(19) United States
(12) Patent Application Publication
(10) Pub. No.: US 2014/0361542 A1
(43) Pub. Date: Dec. 11, 2014

(54) SYSTEMS AND METHODS FOR STORING AND GENERATING ENERGY

(71) Applicant: Alpha Wolf Consulting, Inc., Newtown, MA (US)

(72) Inventor: Mason L. Ham, Dover, NH (US)

(21) Appl. No.: 14/467,380

(22) Filed: Aug. 25, 2014

Related U.S. Application Data
(63) Continuation of application No. 13/094,812, filed on Apr. 26, 2011.
(60) Provisional application No. 61/327,928, filed on Apr. 26, 2010.

(51) Int. Cl. F03B 13/26

(52) U.S. Cl. CPC F03B 13/262
USPC 290/53

(57) ABSTRACT

A method for storing potential energy and generating electrical energy. The method has the steps of accumulating and storing potential energy, converting the potential energy to mechanical energy at the election of a user, and converting the mechanical energy to electrical energy. There are various embodiments of energy storage and generation systems for carrying out the steps of the method.

### CROSS-REFERENCE TO A PRIOR APPLICATION

The present application is a continuation of U.S. Ser. No. 13/094,812, filed Apr. 26, 2011, which claims priority based upon U.S. Provisional Patent Application 61/327,928, filed Apr. 26, 2010, both of which is incorporated herein by reference.

### BACKGROUND OF THE DISCLOSURE

1. Field of the Disclosure

The present disclosure relates to systems for storing potential energy and generating electrical energy. The present disclosure further relates to methods for storing potential energy and generating electrical energy.

2. Description of the Related Art

There is a need for continued development of alternate energy sources and technologies for harnessing them. One alternate energy source is harnessing potential energy from the ocean and/or other bodies of water. It would be desirable to have systems that utilize the motion of waves, variation in tides, and/or buoyancy effects as sources of energy.

### SUMMARY OF THE DISCLOSURE

According to the present disclosure, there is provided a method for storing potential energy and generating electrical energy. The method has the steps of accumulating and storing potential energy, converting the potential energy to mechanical energy at the election of a user, and converting the mechanical energy to electrical energy.

Further according to the present disclosure, there is provided an energy generation system. The system has a mechanical energy generation apparatus positioned within or contiguous to a tidal body of water having a high tide reference level and a low tide reference level and an electrical generator in communication with the apparatus and adapted to convert mechanical energy to electrical energy. The apparatus has a first stop, a second stop, a guide extending from the first end to the second end, and a float adapted to actuate between the first stop and the second stop along the guide. The apparatus is positioned generally vertical within the body of water. The first stop is positioned in proximity to and preferably below the high tide reference level. The second stop is positioned in proximity to and preferably just above the low tide reference level. The actuation of the float generates mechanical energy that is communicated to the electrical generator.

Further according to the present disclosure, there is provided an energy generation and storage system. The system has one or more mechanical energy generation apparatuses positioned within a body of water (or other liquid) and (ii) one or more electrical generators in communication with the one or more apparatuses and adapted to convert mechanical energy received from the one or more mechanical apparatuses to electrical energy. The apparatus is positioned generally vertically in the body of water. The one or more apparatuses each has a flotation platform, a bottom stop, a guide extending from the flotation platform into the body of water to the bottom stop, a float adapted to actuate along the guide between the flotation platform and the bottom stop, and a source of pressurized gas. The float has a tank adapted to retain gas or water. The tank has first and second valves adapted to control the ingress and egress of gas or water. The tank is adapted such that water can enter through either or both of the first and second valves when the float is in proximity to the flotation platform. The float is adapted such that it can actuate toward the bottom stop after the tank is substantially filled with water. The tank is adapted that it can be in communication with the source of pressurized gas when the float is in proximity to the bottom stop. The tank is adapted such that water can be expelled therefrom through the second valve with pressurized gas through the first valve when the tank is in communication with the source of pressurized gas. The float is adapted such that it can actuate toward the flotation platform after the tank is substantially filled with gas. Actuation of the float generates mechanical energy that can be communicated to the electrical generator to generate electricity.

Further according to the present disclosure, there is provided another energy generation and storage system. The system has a collector adapted to receive rainwater, a container adapted to receive water from the collector continually or periodically, and a guide having a top end and a lower end. The container is adapted to actuate along the guide from the vicinity of the upper end to the vicinity of the lower end. The container is adapted to actuate from the upper end to the lower end when the container is substantially full or at a predesignated weight and it is released. Mechanical energy is generated by the actuation of the container. Mechanical energy is converted to electrical energy in the electrical generator. The counterweight is connected to the container by a cable. The counterweight is heavier than the container when the container is empty or substantially empty. The weight of the counterweight relative to the weight of the container when empty or substantially empty is sufficient to pull the container back up the guide to the vicinity of the upper end.

Further according to the present disclosure, there is provided an energy generation and storage system. The system has first and second sails, a cable, a mechanical converter, and an electrical generator. The first and second sails are connected via the cable. The first and second sails are capable of being furled and unfurled. The first and second sails are capable of receiving solar light and actuating and reciprocating to designated positions. The cable is routed through the platform. The mechanical converter is capable of receiving mechanical energy generated by the actuation of the cable. The mechanical converter is in communication with the electrical generator. The electrical generator receives mechanical energy from the mechanical converter and converts it into electrical energy.

Further according to the present disclosure, there is provided an energy generation and storage system. The system has a platform, an icemaker, first and second guides, and an electrical generator. The guide extends from the generator to the platform. The icemaker is capable of freezing a quantity of water to form a body of ice that floats or actuates along the guide to the platform. The actuation creates mechanical energy that is converted to electrical energy by the electrical generator.

Further according to the present disclosure, there is provided an energy generation and storage system. The system has first and second capture devices, a cable, a mechanical converter, and an electrical generator. The first and second capture devices are connected via the cable. The first and second capture devices are capable of being furled and unfurled. The first and second capture devices are capable of receiving solar light and actuating and reciprocating to designated positions. The cable is routed through the platform. The mechanical converter is capable of receiving mechanical energy generated by the actuation of the cable. The mechanical converter is in communication with the electrical generator. The electrical generator receives mechanical energy from the mechanical converter and converts it into electrical energy.

### DESCRIPTION OF THE FIGURES

FIG. 1 depicts a schematic view of a system in accordance with the present disclosure.

FIG. 2 depicts the view of FIG. 1 wherein the float has actuated toward the bottom of the apparatus.

FIG. 3 depicts a schematic view of a float useful in the present disclosure.

FIG. 4 depicts a schematic view of another system in accordance with the present disclosure.

FIG. 5 depicts a schematic view of another system in accordance with the present disclosure.

FIG. 6 depicts a schematic view of another system in accordance with the present disclosure.

FIG. 7 depicts a schematic view of another system in accordance with the present disclosure.

FIG. 8 depicts a schematic view of another system in accordance with the present disclosure.

FIG. 9 depicts a schematic view of another system in accordance with the present disclosure.

FIG. 10 depicts a schematic view of another system in accordance with the present disclosure.

FIG. 11 depicts a schematic view of another system in accordance with the present disclosure.

FIG. 12 depicts a schematic view of another system in accordance with the present disclosure.

FIG. 13 depicts a view of a paddle useful in the system of claim 12.

FIG. 14 depicts another view of a portion of a paddle useful in the system of claim 12.

FIG. 15 depicts yet another view of a paddle useful in the system of claim 12.

FIG. 16 depicts a schematic view of another system in accordance with the present disclosure.

FIG. 17 depicts a schematic view of another system in accordance with the present disclosure.

FIG. 18 depicts a view of a clockwork mechanism and DC motor/generator useful in the present disclosure.

### DETAILED DESCRIPTION OF THE DISCLOSURE

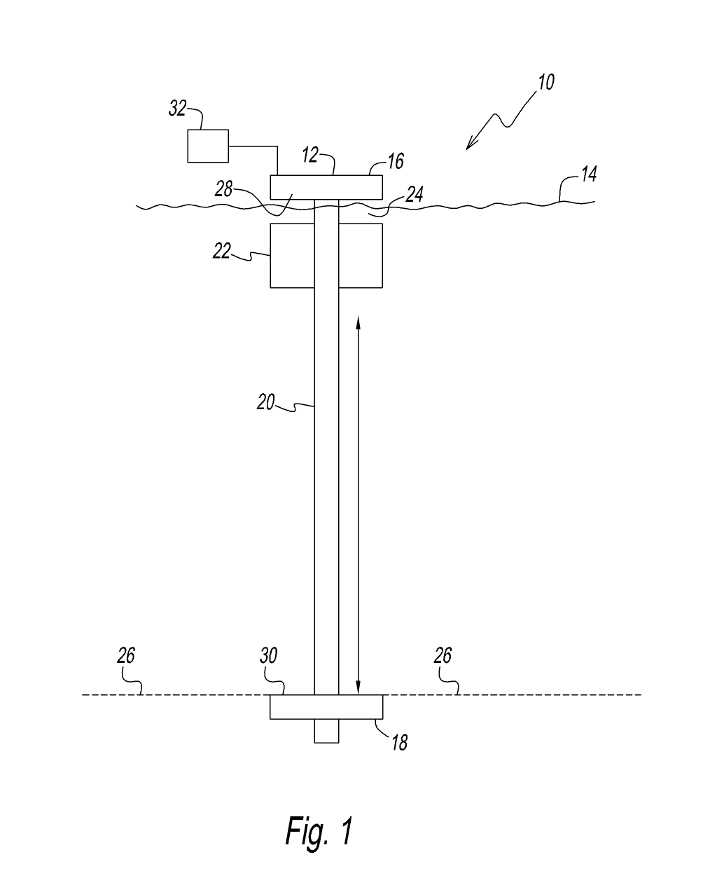

One embodiment of system is depicted in FIG. 1 and is generally referenced by the numeral 10. System 10 has a mechanical energy generation apparatus 12 positioned generally vertically within or immediately contiguous to a tidal body of water (tidal body 14). Apparatus 12 has the following: (a) a first stop 16, (b) a second stop 18, (c) a guide 20 extending from the first end to the second end, and (d) a float 22 adapted to repetitively actuate from first stop 16 to second stop 18 and back to first stop 16 along guide 20.

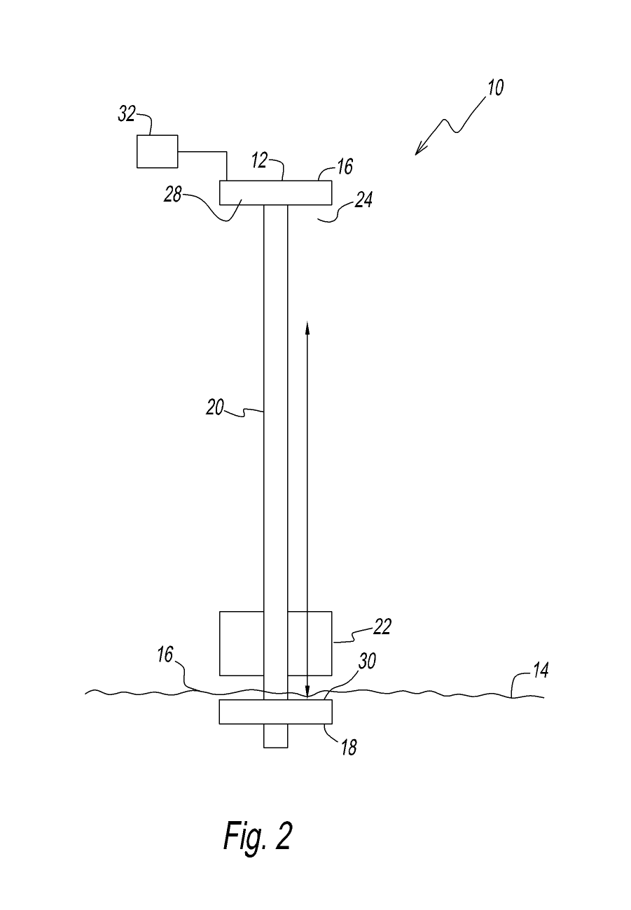

First and second stops 16 and 18 generally take the form of barriers that substantially or completely arrest the further movement or actuation of float 22. Although first and second stops 18 and 20 are shown schematically without particular form in FIGS. 1 and 2, they can take the form of any artificial or natural barrier, e.g., the underside of a boat dock, an erected structure or foundation, a flotation device, or a sea floor.

Guide 20 can take the form of any mechanical guiding or directioning device or article, such as a cable, tether, pipe, conduit, pole, rod, or other member capable of guiding and conveying float 22 between first stop 16 and second stop 18 repetitively. Guide 20 can be of a rigid or flexible material of construction.

A high tide reference level 24 and low tide reference level 26 are established to allow for optimal positioning of first and second stops 16 and 18. Typically, high tide reference level 24 will correspond to an average water level at high tide for the tidal body 14 at the intended location of first stop 16. Correspondingly, low tide reference level 26 will correspond to an average water level at low tide for tidal body 14 at the intended location for second stop 30.

First stop 16 is preferably positioned such that a lower surface 28 thereof is below high tide reference level 24 (lower surface 28 will be the surface that comes into contact with or be in close proximity to float 22). Second stop 18 is preferably positioned such that an upper surface 30 thereof is just above low tide reference level 26 (upper surface 30 will be the surface that comes into contact with or close proximity to float 22). More preferably, first stop 16 is positioned within one foot and most preferably within six inches of high tide reference level 24. Further preferably, second stop 18 is positioned within one foot and most preferably within six inches of low tide reference level 16.

Apparatus 12 is in communication with an electrical generator 32 to convert mechanical energy (from actuation of float 22) to electrical energy. Typically, communication takes the form of a direct or indirect mechanical connection, e.g., a clockwork mechanism (not shown), from apparatus 12 and generator 32. The electrical generator can be any kind known in the art. Although FIGS. 1 and 2 depict generator 32 as being located out of water, i.e., out of tidal body 14, generator 32 may be located in or out of the water at a fixed position or on a flotation device.

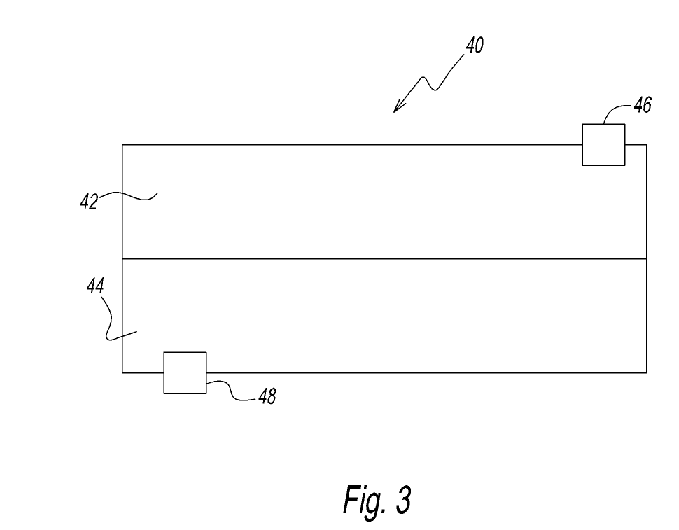

Float 22 can take the form of any device capable of floating on the surface of tidal body 14. Preferred devices take the form of a sealed tank having a free gas therein or a sealed tank having valves therein. An embodiment of a sealed tank having valves therein is shown schematically in FIG. 3 as tank 40. Tank 40 has an upper portion 42 and a lower portion 44. Upper portion 42 has a first valve 46 and lower portion 44 has a second valve 48. Valves 46 and 48 are adapted to control the ingress and egress of air and water. Valves 46 and 48 can be manipulated to allow water to enter tank 40 and air to exit or bleed from tank 40 when float 22 is in proximity to first stop 16. Valves 46 and 48 can be manipulated to allow air or other gas to enter tank 40 and water to exit or bleed from tank 40 when float 22 is in proximity to second stop 18. A sealed tank having only a free gas therein (not shown) is constructed such that the total weight does not exceed the buoyancy generated by the sealed gas therein.

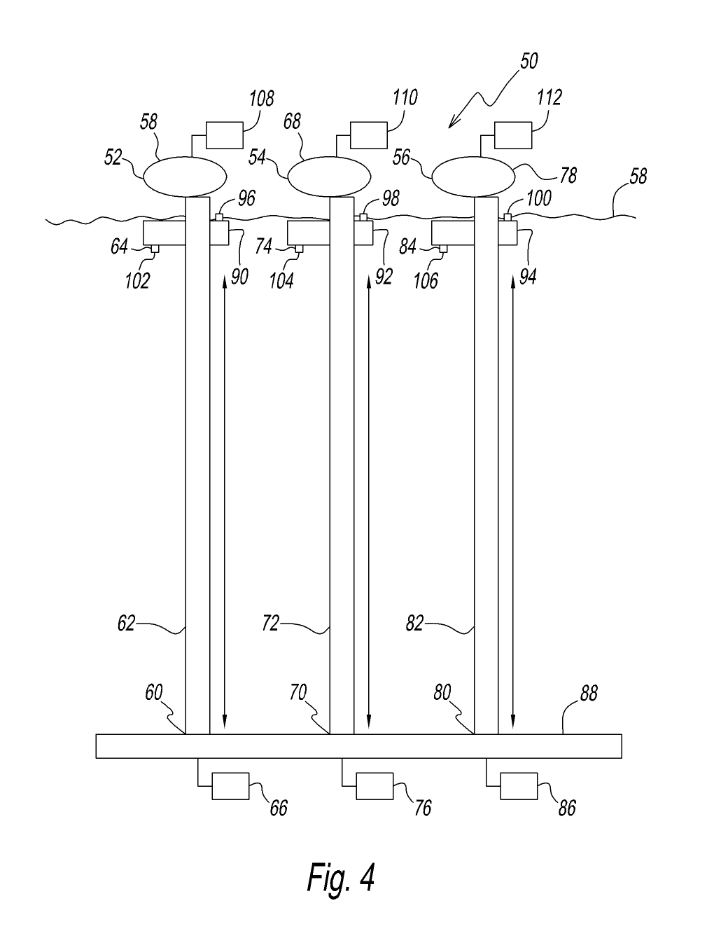

Another embodiment of an energy generation system is depicted in FIG. 4 and is generally referenced with the numeral 50. System 50 has a plurality, e.g., three, mechanical energy generation apparatuses 52, 54, and 56 positioned generally vertically within or immediately contiguous to a tidal body of water (tidal body 58). In lieu of a tidal body of water, a body of liquid may be used. Apparatus 52 has a flotation platform 58, a bottom stop 60, a guide 62, a float 64, and a source of pressurized gas 66. Apparatus 54 has a flotation platform 68, a bottom stop 70, a guide 72, a float 74, and a source of pressurized gas 76. Apparatus 56 has a flotation platform 78, a bottom stop 80, a guide 82, a float 84, and a source of pressurized gas 86. The guides extend from the flotation platforms to the bottom stops. Floats 64, 74, and 84 are adapted to actuate from flotation platforms 58, 68, and 78, respectively, to bottom stops 60, 70, and 80, respectively, back and forth in a continual and repetitive manner along guides 62, 72, and 82, respectively.

Bottoms stops 60, 70, and 80 are interconnected as shown in FIG. 4 in the form of a unitary platform 88 but can, if desired, be interconnected via cable, tether, pipe, conduit, pole, rod, or other known devices (not shown). The interconnecting device can be of a rigid or flexible material of construction. If desired, bottom stops can alternately be configured to be stand-alone or non-interconnected (not shown). If bottom stops are stand-alone or non-interconnected, they can be anchored to the sea floor, shore, or other object so as to enable the apparatus in remaining substantially stationary (not shown). Alternately, a bottom stop (and/or a platform or other bottom stops to which they may be attached) can be made heavy enough so that they remain substantially stationary when the float ascends from the bottom stop to a flotation platform.

Floats 64, 74, and 84 have tanks 90, 92, and 94, respectively, adapted to retain either gas or water. Tanks 90, 92, and 94 have first valves 96, 98, and 100, respectively, and second valves 102, 104, and 106, respectively, adapted to control the ingress and egress of gas or water. Tanks 90, 92, and 94 are adapted such that water can enter through either or both of the first valves 96, 98, and 100 and second valves 102, 104, and 106 when floats 64, 74, and 84 are in proximity to flotation platforms 58, 68, and 78. Floats 64, 74, and 84 are adapted such that they actuate toward bottom stops 60, 70, and 80 after tanks 90, 92, and 94 are substantially filled with water. When floats 64, 74, and 84 are in proximity to bottom stops 60, 70, and 80, tanks 90, 92, and 94 are adapted to communicate with sources of pressurized gas 66, 76, and 86, respectively. Tanks 90, 92, and 94 are adapted such that pressurized gas is injected through first valves 96, 98, and 100, respectively, and water is forcibly expelled through second valves 102, 104, and 106, respectively. It should be understood that the relative positioning of first valves 96, 98, and 100 and second valves 102, 104, and 106 in tanks 90, 92, and 94 is not critical and that first valves and second valves may be used interchangeably to pass gas or water. After tanks 90, 92, and 94 are substantially filled with gas, floats 64, 74, and 84 are adapted to actuate toward flotation platforms 58, 68, and 78, respectively.

Apparatuses 52, 54, and 56 is in communication with electrical generators 66, 76, and 86, respectively, to convert mechanical energy (from actuation of floats 64, 74, and 84, respectively) to electrical energy. Typically, communication takes the form of a direct or indirect mechanical connection, e.g., a clockwork mechanism (not shown), from apparatuses 52, 54, and 56 and generators 66, 76, and 86. The electrical generator can be any kind known in the art. Although FIGS. 1 and 2 depict generators 66, 76, and 86 as being located in water, i.e., out of tidal body 58, generators 66, 76, and 86 may be located in or out of the water.

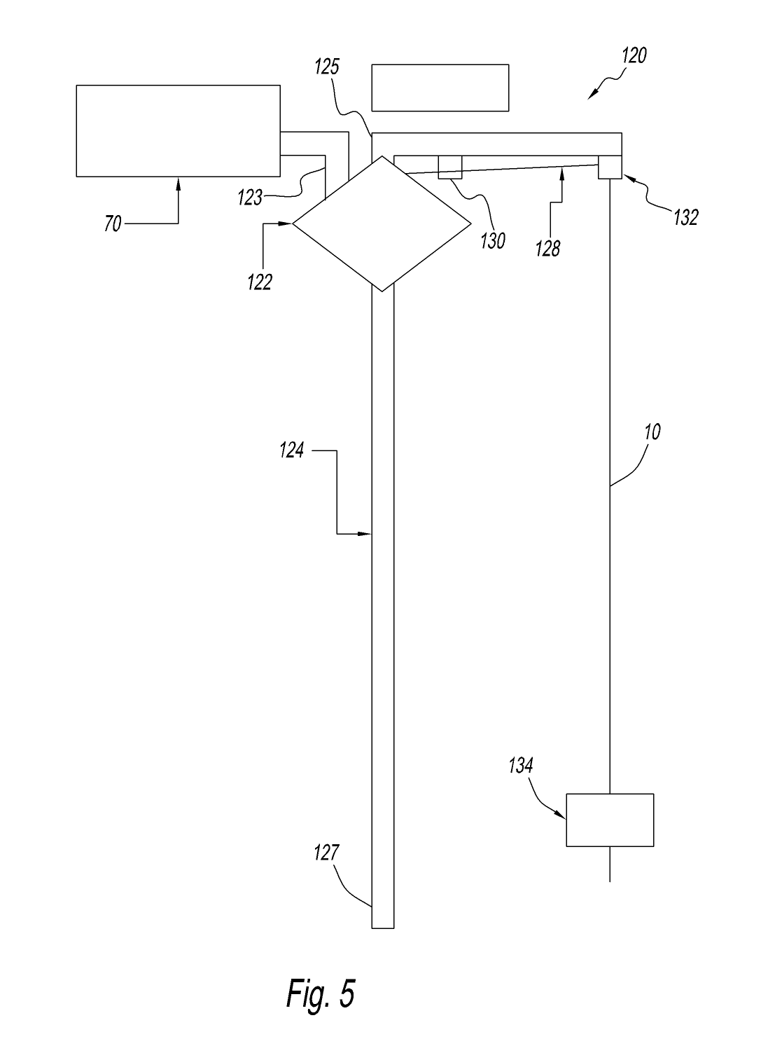

Another embodiment of an energy storage and generation system is shown in FIG. 5 and is generally referenced by the numeral 120. Collector 70 is a receptacle that collects rainwater. Container 122 receives water from collector 70 through a conduit 123 either on a continuous or periodic basis. Container 122 is adapted to actuate along a guide 124 generally from one end to the other depending on the weight of water in container 122. When container 122 is substantially full or at a predesignated weight, it can be released to fall from an upper end 125 of guide 124 to a lower end 127 of guide 124. Mechanical energy is generated by the descent of container 122 along guide 124. Mechanical energy is converted to electrical energy in electrical generator 120. After container 122 reaches the vicinity of lower end 127, most or substantially all water therein is released such that the weight of container 122 is reduced. Container 122 is connected to a counterweight 134 by a cable 10, which is run through a series of blocks 130 and 132 such that counterweight 134 is heavier than container 122 when container 122 is empty or substantially empty. The weight of counterweight 134 relative to container 122 when substantially empty is sufficient to pull container 122 back up guide 124 to the vicinity of upper end 125.

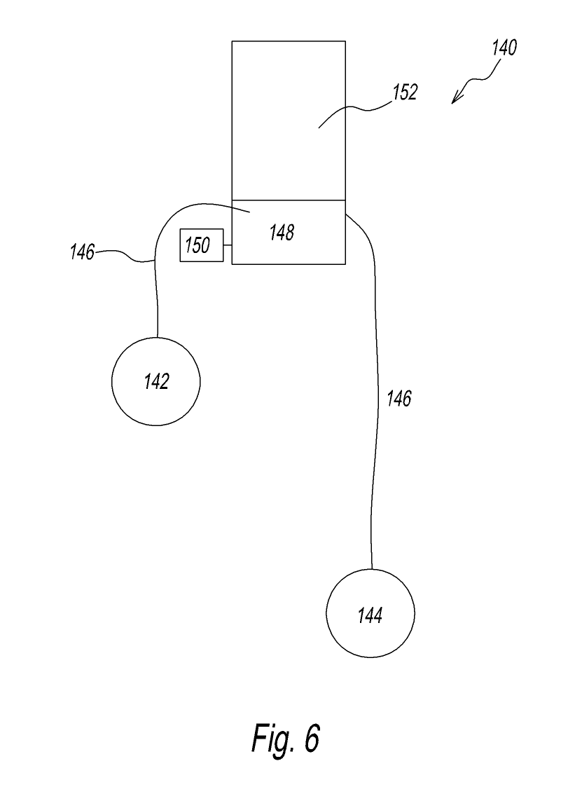

Another embodiment of an energy storage and generation system is shown in FIG. 6 and is generally referenced by the numeral 140. The system generates electricity using solar energy or radiation, i.e., light. The system has sails 142 and 144, a cable 146, a mechanical converter 148, an electrical generator 150, and a gravity well 152.

Sails 142 and 144 are connected via cable 146. Sails 142 and 144 actuate and reciprocate along cable 146. Sails 142 and 144 are alternately furled and unfurled, i.e., one is furled while the other is unfurled. The unfurled sail receives solar energy from the sun (not depicted) and moves or actuates to a designated position. The unfurled sail pulls cable 146 and the furled sail to another designated position. Then the unfurled sail is furled and the furled sale unfurled. This switch in furling causes the sails to reverse course and return to their original positions. The actuation cycle can be repeated continually or continuously. FIG. 6 illustrates a portion of the cycle, wherein sail 144 has actuated and pulled cable 146 and sail 142 with it. Sail 144 can then be unfurled and sail 142 furled (not shown) to cause reverse actuation.

Sails 142 and 144 can be constructed of any material that is capable of being actuated when exposed to solar energy or radiation, i.e., light. Preferred materials are metal. A most preferred material is aluminum. Sails 142 and 144 are preferably constructed of a relatively thin material with a relatively broad cross-section. A preferred material form is a metal foil.

Cable 146 is routed through platform 148, which receives mechanical energy generated by the actuation of cable 146 via a clockwork mechanism, for example. Mechanical converter 148 is in communication with electrical generator 150, which receives mechanical energy from mechanical converter 148 and converts it into electrical energy.

Gravity well 152 can take the form of any massive body, such as a planet or moon. System 140 is positioned within the orbit of gravity well 152.

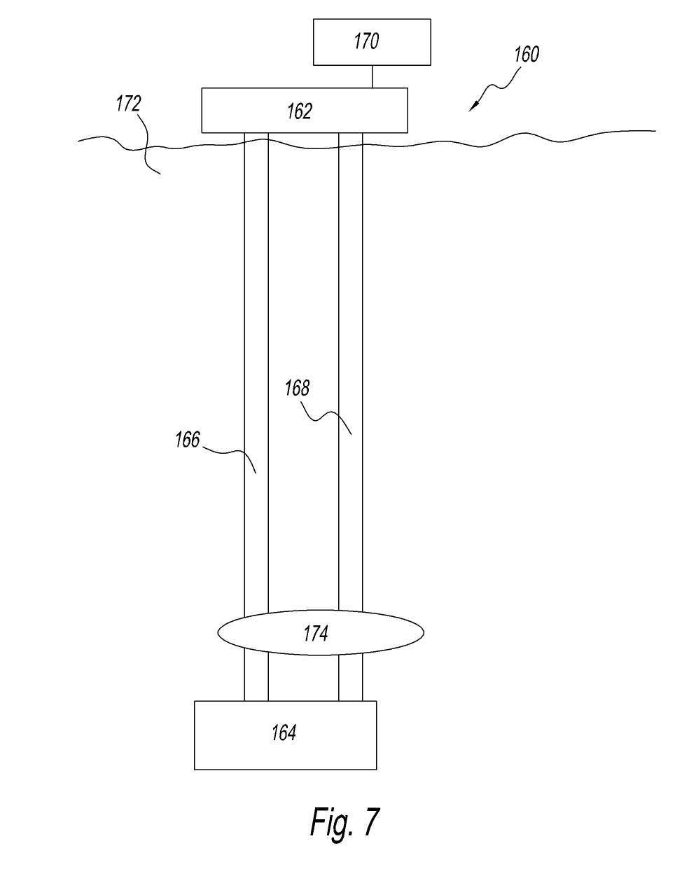

Another embodiment of an energy storage and generation system is shown in FIG. 7 and is generally referenced by the numeral 160. System 160 has a platform 162, an icemaker 164, first and second guides 166 and 168, and an electrical generator 170. System 160 is positioned in a body 172 of water. Icemaker 164 freezes a quantity of water from body 172 to form an ice body 174. As ice is less dense than liquid water, ice body 174 naturally floats via buoyancy upward through water body 172 toward platform 162. Ice body 174 floats along the first and second guides 166 and 168 that are in connection with platform 162 to create mechanical energy. Platform 162 preferably has a means for transferring the mechanical energy generated by guides 166 and 168 to generator 170. Suitable means for transferring mechanical energy include, for example, a clockwork mechanism (not shown). Guides 166 and 168 can take the form of a cable, tether, pipe, conduit, pole, rod, or other member capable of guiding and conveying ice body 174. If water body 172 is a body of salt water, such as the ocean, salt will be expelled from ice body 174 during the freezing process—yielding ice of fresh, substantially non-salty water. If the freezing process is carried out in deep water, the elevated hydrostatic pressure will have the effect of lowering the freezing temperature. The lower freezing temperature will yield ice that is at a lower temperature when harvested providing a deeper heat sink.

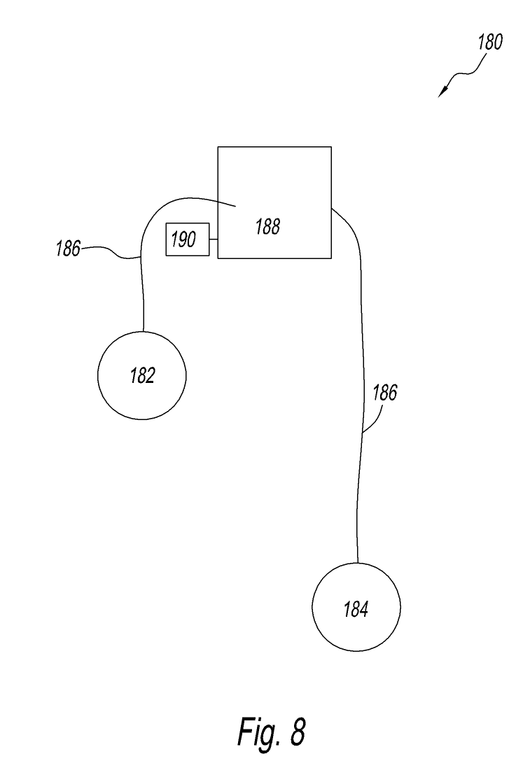

Another embodiment of an energy storage and generation system is shown in FIG. 8 and is generally referenced by the numeral 180. The system generates electricity using flow energy, e.g., water. The system has capture devices 182 and 184, a cable 186, a mechanical converter 188, and an electrical generator 190.

Capture devices 182 and 184 are connected via cable 186. Capture devices 182 and 184 actuate and reciprocate along cable 186. Capture devices 182 and 184 are alternately furled and unfurled, i.e., one is furled while the other is unfurled. The unfurled capture device receives flow energy (not depicted) and moves or actuates to a designated position. The unfurled capture device pulls cable 186 and the furled capture device to another designated position. Then the unfurled capture device is furled and the furled sale unfurled. This switch in furling causes the capture devices to reverse course and return to their original positions. The actuation cycle can be repeated continually or continuously. FIG. 8 illustrates a portion of the cycle, wherein capture device 184 has actuated and pulled cable 186 and capture device 182 with it. Capture device 184 can then be unfurled and capture device 182 furled (not shown) to cause reverse actuation.

Capture devices 182 and 184 can be constructed of any material that is capable of being actuated when exposed to flow energy. Preferred materials are rigid materials of metal or plastic. Capture devices 182 and 184 are preferably constructed of a relatively thin material with a relatively broad cross-section in the nature of a sail.

Cable 186 is routed through platform 188, which receives mechanical energy generated by the actuation of cable 186. Mechanical converter 188 is in communication with electrical generator 190, which receives mechanical energy from mechanical converter 188 and converts it into electrical energy. Suitable means for transferring mechanical energy include, for example, a clockwork mechanism (not shown).

In another embodiment, there is another system for storing potential energy and generating electrical energy. The system has a means for accumulating and storing potential energy, a means for converting the potential energy to mechanical energy at the election of a user, and a means for converting the mechanical energy to electrical energy.

The following are examples of the disclosure and are not to be construed as limiting.

### EXAMPLES

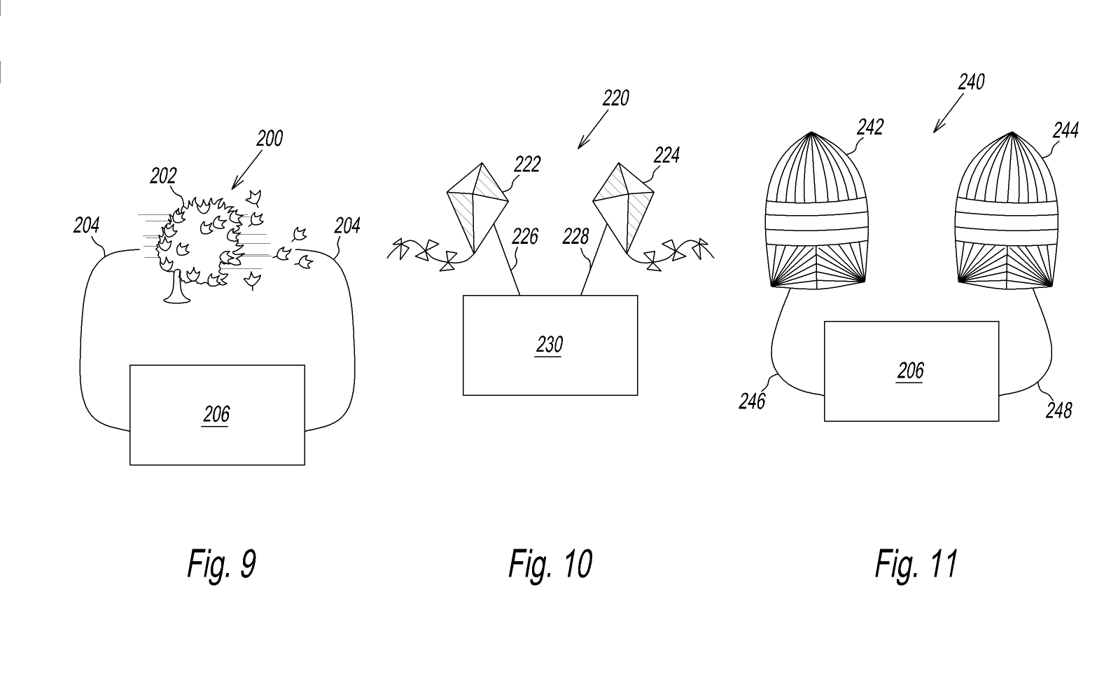

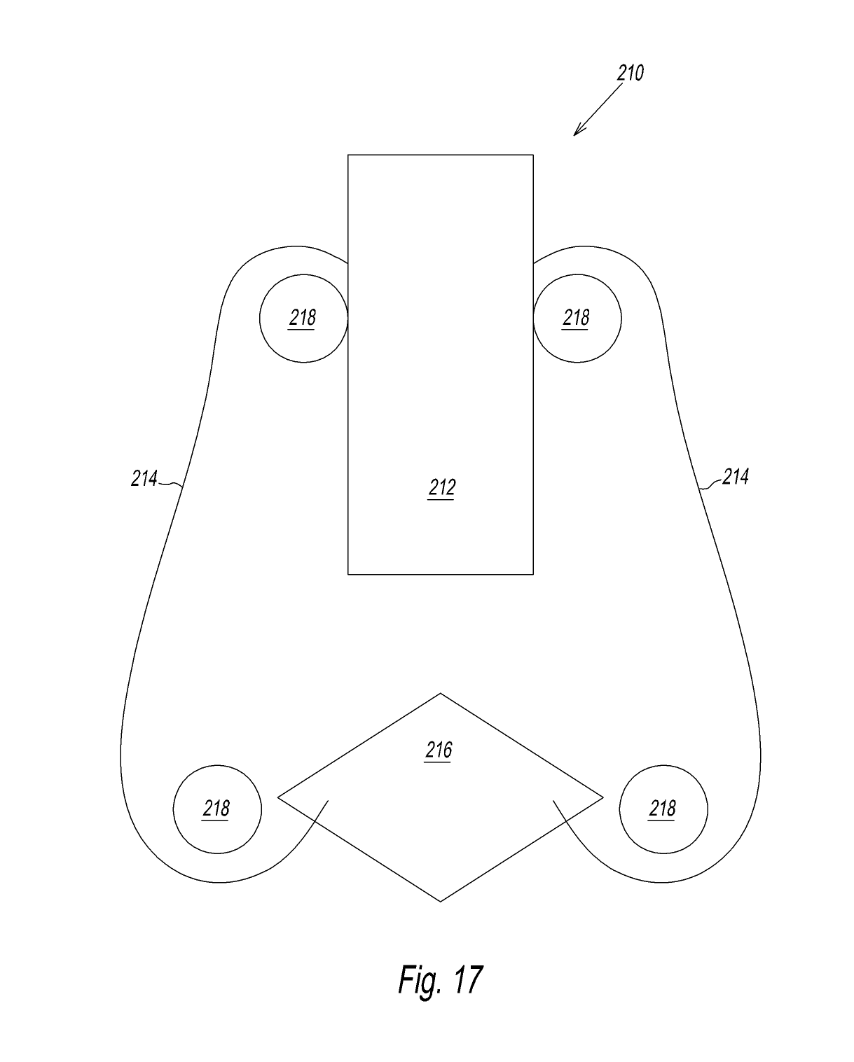

An example employing the swaying action of a tree (as a result of wind force) to generate energy is shown in FIGS. 9 and 17. In FIG. 9, a system 200 is made up of a tree 202, a cable 204 (or a rope), and a clockwork mechanism 206. Cable 204 is connected directly or indirectly to tree 202. As the tree 202 sways, the actuating of cable 204 transfers mechanical energy to mechanism 206 via turning of a shaft (not shown). Mechanism 206 is connected to a DC motor and generator (not shown) to create electrical energy. In FIG. 9, a system 210 is made up of a tree 212, a cable 214 (or a rope), a clockwork mechanism 216, and a plurality of swivel blocks 218. The swivel blocks 218 guide and position cable 214 with respect to tree 212 and mechanism 216 so that cable 214 is stabilized and adapted to actuate. As the tree 222 sways, the actuating of cable 214 transfers mechanical energy to mechanism 216 via turning of a shaft (not shown). Mechanism 206 is connected to a DC motor and generator (not shown) to create electrical energy.

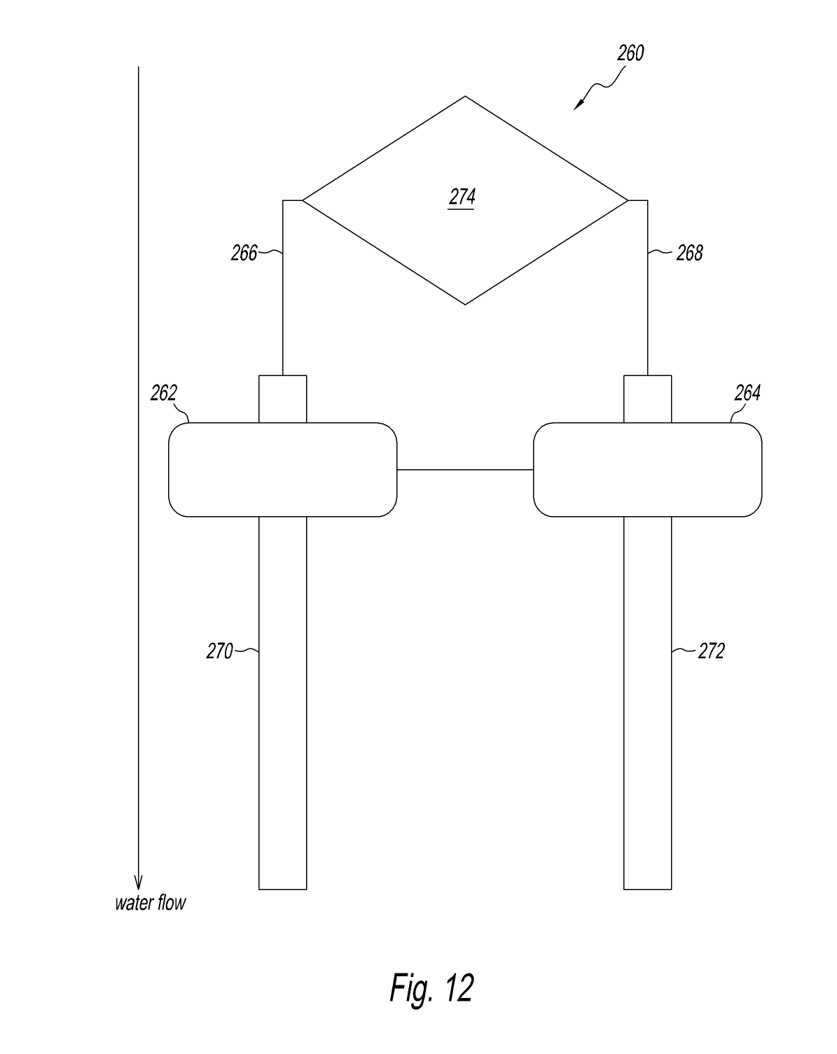

Another example employs the force of wind to generate and store energy is shown in FIG. 10. In FIG. 10, a system 220 is made up of kites 222 and 224, which are attached by strings 226 and 228 to a pair of trains or cars (not shown) on a pair of tracks (not shown). The trains actuated along the tracks as wind blew kites 222 and 224. The trains were connected to a clockwork mechanism 230 via ropes (not shown), which were wound around a shaft (not shown) of mechanism 230. The general configuration of a pair of tracks is shown by way of illustration in a different system in FIG. 12. Potential energy is stored in the system by exposing kites 222 and 224 to wind energy yet retaining the trains in locked position (not shown) and releasing the trains from locked position when access to the potential energy is desired. The energy of the shaft could be accessed when desired by a user. As one kite and its train are actuating down a track, the other kite and train are being drawn in by hand such that kites 222 and 224 are actuating sequentially and oppositely during operation. The shaft was connected to a DC motor and generator (not shown) to generate electricity. The system produced 300 mA and 5 to 23 volts of electricity when tested. If desired, a coiled shaft (not shown) can be employed in mechanism 230 to further store potential energy converted from the kinetic energy received from kites 222 and 224.

Another example employs the force of wind to generate and store energy is shown in FIG. 11. In FIG. 11, a system 240 is made up of sails 242 and 244, which were directly attached by ropes 246 and 248 to a pair of trains or cars (not shown) on a pair of tracks (not shown). The trains actuated along the tracks as wind blew sails 242 and 244. The trains were connected to a clockwork mechanism 250 via ropes 246 and 248, which are wound around a shaft (not shown) of mechanism 250. The general configuration of a pair of tracks is shown by way of illustration in a different system in FIG. 12. Potential energy is stored in the system by exposing sails 242 and 244 to wind energy yet retaining the trains in locked position (not shown) and releasing the trains from locked position when access to the potential energy is desired. As one sail and its train are actuating down a track, the other sail and train are being drawn in by hand such that sails 242 and 244 are actuating sequentially and oppositely during operation. The energy of the shaft can be accessed when desired by a user. The shaft is connected to a DC motor and generator (not shown) to generate electricity. The system produced electricity when tested. If desired, a coiled shaft (not shown) can be employed in mechanism 250 to further store potential energy converted from the kinetic energy received from sails 242 and 244.

Another example employs the force of the flow of water to generate and store energy is shown in FIGS. 12 to 15 and is generally referenced by the numeral 260. Planar paddles 262 and 264 are directly attached at their undersides to a pair of trains or cars (not shown), which actuate sequentially and oppositely along a pair of tracks 270 and 272. The trains are attached by ropes 266 and 268 to clockwork mechanism 274. The trains actuate along tracks 270 and 272 as water flows against planar paddles 262 and 264. The trains are connected to a clockwork mechanism 274 via ropes 266 and 268, which are wound around a shaft (not shown) of mechanism 274. Potential energy is stored in the system by exposing planar paddles 262 and 264 to wind energy yet retaining the trains in locked position (not shown) and releasing the trains from locked position when access to the potential energy is desired. As one planar paddle and its train actuate down a track, the other sail and train are actuating in the opposite direction during operation. The shaft is connected to a DC motor and generator (not shown) to generate electricity. If desired, a coiled shaft (not shown) can be employed in mechanism 274 to further store potential energy converted from the kinetic energy received from paddles 262 and 264.

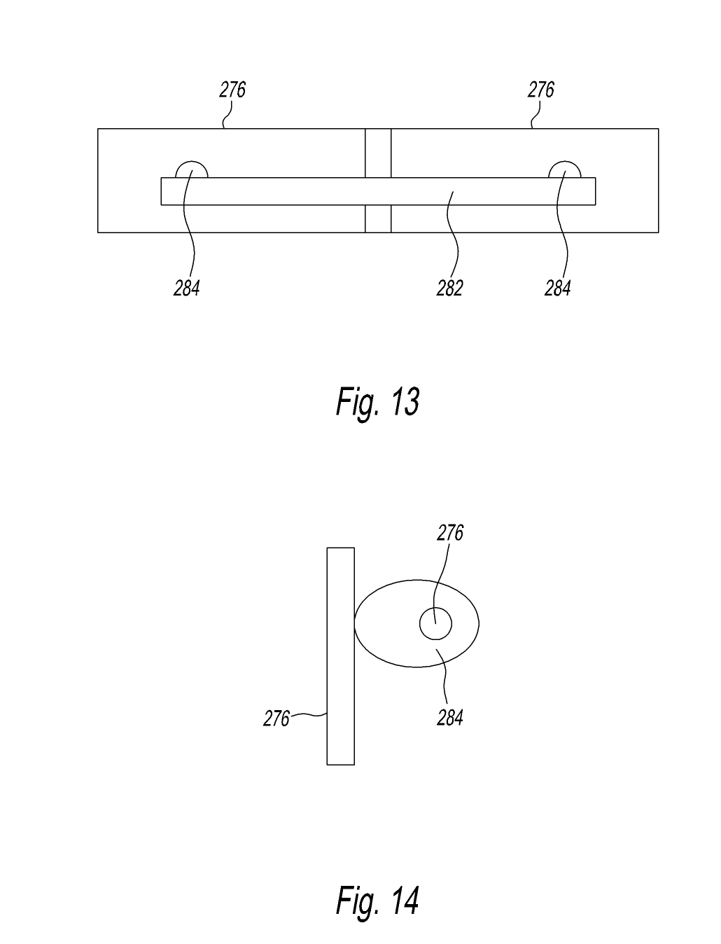

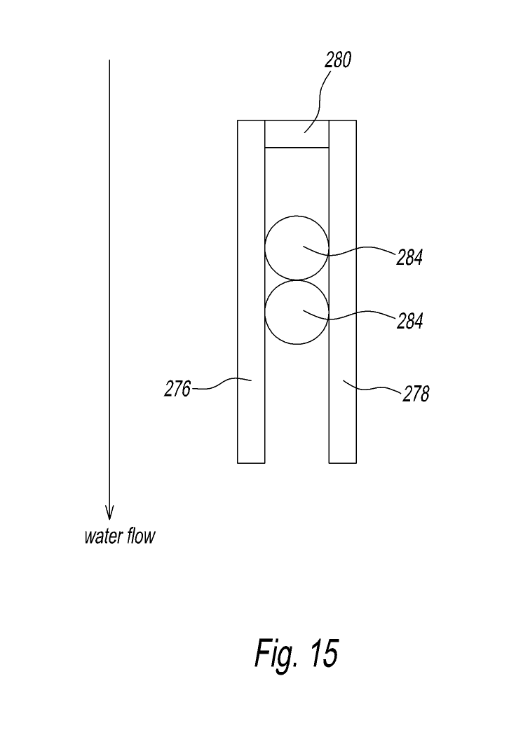

FIGS. 13 to 15 depict the structure of paddle 262, and, concomitantly, paddle 264, in open or “unfurled” position. Paddle 264 has paddle sections 276 and 278 and hinge 280, which allows paddle sections 276 and 278 to actuate therebetween. A dowel 282 is threaded through a pair of eyescrews 284 to hold paddle 264 locked in an open position. Dowel 282 in conjunctions with paddle 262 creates the appearance of a ridged plane. FIG. 15 shows paddle 262 in a closed or “furled” position, which occurs when paddle 262 is exposed to flow energy and dowel 282 has been removed. It is noted that other methods of opening and closing a paddle may be employed, such as the use of magnets, springs, hydraulics, and other electromechanical devices.

System 260 was placed in a plastic tub and two water hoses were inserted to simulate the flow or energy current of a river. The sprocket on the DC motor was replaced with a friction block. The system generated 2 A (amperes) at 12 V (volts) of electricity.

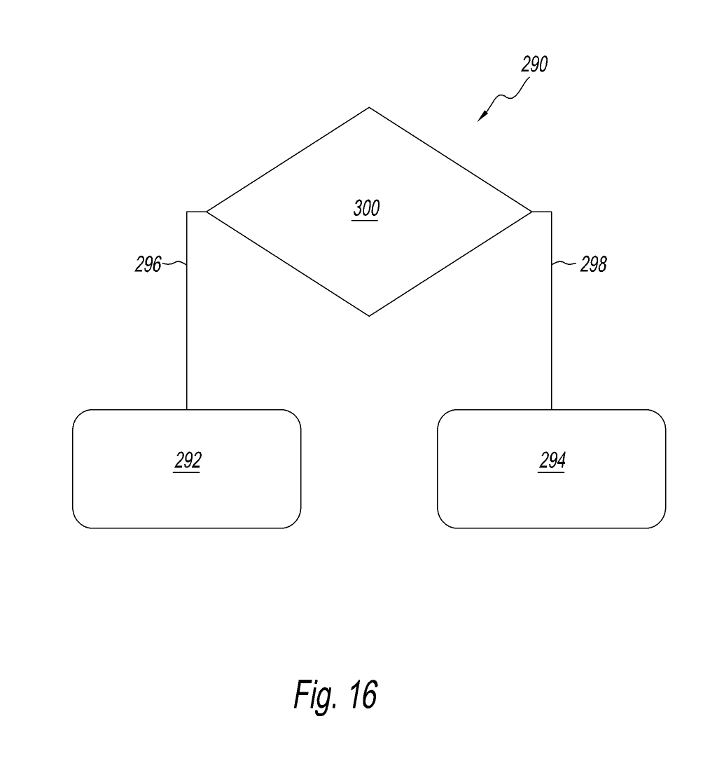

Another example of a system that employs the weight of water to generate and store energy is shown in FIG. 16 and is generally referenced by the numeral 290. Containers 292 and 294 are attached by ropes 296 and 298 to clockwork mechanism 300 at a pinch block (not shown). Containers 292 and 294 are filled with and emptied of water alternately. Containers 292 and 294 actuate alternately and are connected to by the same rope. The pinch block is connected to a shaft (not shown) of a DC motor and generator (not shown) to generate electricity. System 290 was tested and generated measurable electricity.

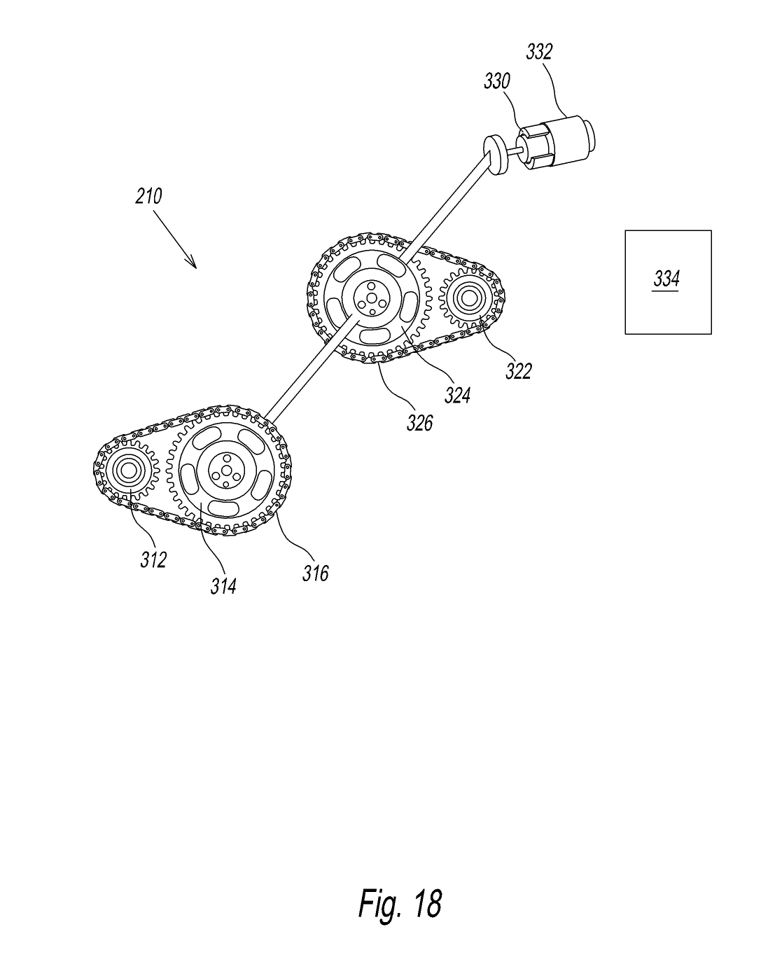

An example of a clockwork mechanism useful in the systems of the disclosure is shown in FIG. 18 and is generally referenced by the numeral 310. Mechanism 310 has a first paired sprocket assembly having a small sprocket 312, a large sprocket 314, and a drive chain 316 and a second paired sprocket assembly having a small sprocket 322, a large sprocket 324, and a drive chain 326. Mechanism 310 has a shaft driven by the first and second sprocket assemblies. The shaft is attached to a DC motor 330 and a generator 332. Charge generated by generator 332 is measured for properties such as voltage and amperage in measuring device 334. In other mechanisms, sprocket assemblies can be replaced with friction blocks, e.g., an actuating rope is in contact with a friction block attached to a shaft or directly to a DC motor.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

What is claimed is:

1. A method for storing potential energy and generating electrical energy, comprising the steps of:
accumulating and storing potential energy within a system,
releasing and converting the potential energy in the system to mechanical energy,
converting the mechanical energy from the system to potential energy accumulated and stored in a mechanism,
releasing and converting the potential energy accumulated and stored in the mechanism to mechanical energy at the election of a user, and
conveying the mechanical energy from the mechanism to an electrical generator to generate electrical energy.

2. The method of claim 1, wherein accumulating and storing potential energy includes positioning a mechanical energy generation apparatus within a tidal body of water having a high tide reference level and a low tide reference level and wherein the apparatus has a first stop, a second stop, a guide extending from the first stop to the second stop, and a float adapted to actuate between the first stop and the second stop along the guide, wherein the apparatus is positioned generally vertical within the tidal body of water, wherein the first stop is positioned in proximity to the high tide reference level, wherein the second stop is positioned in proximity to the low tide reference level, wherein converting the potential energy to mechanical energy includes allowing the float to actuate, and wherein converting the mechanical energy to electrical energy includes electrically connecting an electrical generator with the apparatus.

3. The method of claim 2, wherein a lower surface of the first stop is positioned within one foot of the high tide reference level, wherein an upper surface of the second stop is positioned within one foot of the low tide reference level.

4. The method of claim 2, wherein the float is a sealed tank having a free gas therein.

5. The method of claim 2, wherein the float is a tank adapted to retain air or water, wherein the float has an upper portion and a lower portion, wherein the float has a first valve in the upper portion thereof adapted to control the ingress and egress of air or water, wherein the float has a second valve in the lower portion thereof adapted to control the ingress and egress of air or water, wherein water can enter the float when the float is in proximity to the first stop, wherein water can exit the float when the float is in proximity to the second stop.

6. The method for storing potential energy and generating electrical energy of claim 1, wherein accumulating and storing potential energy includes positioning a mechanical energy generation apparatus within a tidal body of water having a high tide reference level and a low tide reference level and wherein the apparatus has a first stop, a second stop, a guide extending from the first stop to the second stop, and a float adapted to actuate between the first stop and the second stop along the guide, wherein the apparatus is positioned generally vertical within the tidal body of water, wherein the first stop is positioned in proximity to the high tide reference level, wherein the second stop is positioned in proximity to the low tide reference level, wherein converting the potential energy to mechanical energy includes allowing the float to actuate, and wherein converting the mechanical energy to electrical energy includes electrically connecting an electrical generator with the apparatus, and wherein the float is a sealed tank having a free gas therein.
